(19) United States
(12) Patent Application Publication
(10) Pub. No.: US 2011/0284174 A1
(43) Pub. Date: Nov. 24, 2011

(54) Method for controlling environmental conditions of livestock based upon the dynamics between temperature and wind chill

(76) Inventor: Kevin Lynn Hoover, Oley, PA (US)

(21) Appl. No.: 12/784,574

(22) Filed: May 21, 2010

(51) Int. Cl. E05F 15/20

(52) U.S. Cl. 160/405

(57) ABSTRACT

A method for controlling the temperature of an enclosure by opening or lowering curtains based on the difference between inside and outside temperatures and the prevailing wind velocity, direction, and wind chill. In one example, temperature of a cow barn is controlled, in part, by determining the direction from which the wind is blowing and using that and the wind velocity and internal and external temperatures to activate a controller to open or close barn curtains in order to warm or cool the barn. This invention can be applied to any livestock that is housed in any type of enclosure which makes use of automated curtains.

### BACKGROUND OF INVENTION

The present invention relates in general to a method for controlling the internal temperature of a structure or enclosure used to house living commercial organisms, such as animal or plant life that employs the control of ventilation curtains using dynamic temperature and wind chill variables to energize and operate the curtains.

As is well known to agricultural scientists and farmers, the impact of temperature on animals is extensive in commercial animal production facilities. Factors such as cold, wind, snow, rain and mud can create stress during the winter months. All these factors alter the maintenance energy requirement of livestock. Maintenance requirement can be defined, as the nutrients required for keeping an animal in a state of balance so that body substance is neither gained nor lost.ⁱ

So, it can be shown that the primary effect on animals is due to temperature. For example, high temperatures, usually during the summer months in the United States have been found to cause heat stress in cattle, which in turn impacts estrous behavior, conception rates, and lactation in dairy cattle. Cold temperatures also place stress upon dairy cattle. Cold and windy weather alter the nutrients required to keep the animal in a state of balance so that they do not gain or lose body substance (weight/mass).ⁱⁱ

In general, the performance, health, and well being of livestock are strongly affected by climate. Heat waves and or extended periods of severe cold winter weather cause significant losses in one or more regions of the United States. In the past 10 yr, economic losses in the feedlot industry alone averaged between $10 million to $20 million/year as a result of adverse climatic conditions. For each animal that dies from climatic stress, corresponding economic losses approach $5,000 due to mortality and associated live animal performance losses. As has been stated by experts in the field of animal management, altering the microclimate by providing protection from the environment is one of the most useful tools to help livestock cope with climatic conditions. For most livestock, facilities and management programs do not need to eliminate environmental stress completely, but rather minimize the severity of the environmental challenge and aid the animal in adapting to it. One suggested method to minimize environmental impact from wind and hot/cold weather is to use permanent wind barriers (curtains) to minimize weather-related stress for feedlot cattle.ⁱⁱⁱ

Building/enclosure curtains are commonly found in cattle barns and are generally made from high performance polyethylene laminates or other materials which open and close to facilitate air exchange. A building/enclosure, such as a cow barn, generally has a series of curtains that protect the roof vent and all sides of the enclosure. Curtains are often installed to cover and protect the roof ridge vent, the top middle sides of the building, and the bottom sides of the building/enclosure. These three curtain areas are designed so that the farmer/operator can open or close different curtains depending on the direction of the wind and the severity of the weather.

In the past, these curtains were operated manually; an operator would have to hand-crank the curtains up or down depending on weather conditions. However, in recent years these curtains have been motorized to allow the operator to open and close the curtains with a flick of a switch. More recently, the curtain motors have been connected to computerized controllers which use microprocessors to activate or energize a curtain motor to open or close based on a set of environmental parameters.

Most commonly, the computerized controller, which contain microprocessors, are physically or wirelessly connected to sensors that read environmental conditions such as temperature and wind velocity. Data from the sensors is relayed to the microprocessors in the controller, which are programmed with pre-defined algorithms that record the environmental conditions and in turn use the data to determine how much or how little to open or close building/enclosure curtains.

A specific problem with all prior art environmental controllers is that the automation of the curtains is controlled by some type of a “fixed set point.” For example, if the set point is set at 70 degrees, the curtain motor sensor will activate and open or close the curtain a certain amount (up or down) when the temperature reaches 70°. The span between open and closed can be set. In other words, this automation is “set” to open or close the curtains in fixed increments at fixed degree settings. Fixed set points do not allow for dynamic adjustment of curtains. With a fixed set point, all that is happening is that the curtains are opened or closed when a fixed parameter is met, and while some prior art does take into account how livestock respond to temperature over a period of time, non use actual second to second changes in temperature and wind chill.

Climate and weather are dynamic; wind and temperature can dramatically change over a period of a few minutes/hours in most of the United States. The microclimate of a livestock building/enclosure is also dynamic; depending on a multitude of factors such as the buildup of noxious gasses, the most dangerous being ammonia (NH₃), methane (CH₄), carbon dioxide (CO₂), and hydrogen sulfide (H₂S, among others. In modern livestock barns, proper indoor air quality is imperative to maintain the health and productivity of farm animals.

The curtains that cover the sides of a building/enclosure can be used to regulate the amount of gasses that buildup in a barn. A much better way that raising or closing curtains based on a fixed set point is to open or close the curtains in response to the more dynamic natural weather conditions.

### SUMMARY OF THE INVENTION

The present invention uses no fixed set point to open or close building/enclosure curtains, using however a dynamic set point. Dynamic set point refers to a set point that is constantly shifting based on a comparison of the inside temperature, the outside temperature and the wind chill.

The present invention comprises a method whereby temperature sensors and wind chill sensors constantly monitor weather and climate conditions. The data from this monitoring is relayed to a controller's microprocessor. The microprocessor contains unique algorithms (curtain temperature control logic) that will open or close the curtains in response to a set of conditions incorporated into the algorithms. The temperature control logic directions whether to energize the curtain motors to open or close. In prior art, the temperature is checked on a timed interval (e.g., every four minutes) and then, if the building/enclosure's temperature is above the set point, the curtains will open for a timed interval (e.g., 10 seconds) or if the building's temperature is below the set point, the curtain closes for a timed interval (e.g., 10 seconds). This methodology is based on a fixed set point but does not take into consideration the actual wind chill effect on building/enclosure temperature.

A specific example of the application of the present invention to control the temperature of a cow barn may better illustrate the essence of the invention. In cold weather, the outside temperature of a cattle barn may be colder than the inside temperature, thus effecting the performance, health and well being of the cows. Ventilation fans will be turned off so as to not pass cold air across already cold cows. Curtains will be closed to allow the inside temperature to rise, thus increasing the inside temperature of the barn. Using the prior art's fixed set point methodology, the curtains will be opened or closed only when a fixed temperature is sensed. However, with the use of a dynamic set point, as illustrated in this present invention, the each curtain can be opened or closed dynamically, depending on a number of combined factors, such as the curtain's position in the wind, the wind direction and velocity, and the internal and external temperatures. With the present invention, in cold weather, the controller will try to keep the inside temperature of the barn warmer than the outside temperature. In most barns there are three sets of curtains on each side of the barn: ridge vent curtains, which are located along the open vent at the roof ridge of the barn; the top curtains, which usually run from right below the barn eave to midway down each side of the barn, and the close curtain that run from midway down each side to the ground. In the present invention, there are unique algorithms for each type of curtain. These algorithms are based on observed weather conditions and experiential observations and data retrieval. In one example of the present invention: when the outside temperature is 0° F. the wind chill is determined and both temperature and wind chill are used to determine how much to open or close the top curtain on the north side a barn. Using the temperature and wind chill data, the controller's algorithm calculates that to increase the inside temperature of the barn to 20° F. that the curtains need to close by 12 inches. The controller then sends a message to the curtain motor and the motor energizes the curtain to move toward the closed position. One of the powers of the dynamic fixed point methodology is that the controller is constantly sensing temperatures and wind chill an updating the calculations. So, if fifteen minutes later the temperature inside the barn raises to 22° F. the controller's algorithms will have performed a recalculation and determined that the north-facing top curtain should now energize the curtain motor to move the curtain toward a more open position. Whereas in a fixed point methodology the curtains will open or close only when the next set point is reached; with a dynamic set point methodology, as embodied in the current patent, the curtains will open and close based on the environmental conditions (temperature, wind chill, wind velocity) whenever the environmental conditions change. In essence, the environmental conditions of the barn are monitored, modified, and maintained by acting upon actual measurements of the external and internal environments.

The invention will be described in conjunction with the following drawings in which like reference numerals designate like elements and wherein:

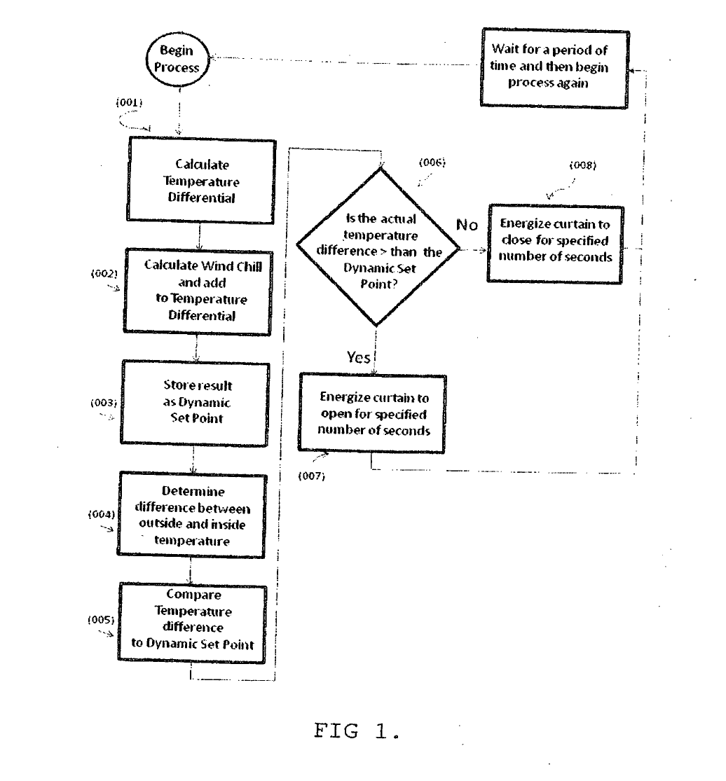

FIG. 1 is a flowchart representation of the main curtain temperature logic showing the steps in the process to determine the dynamic set point and the consequences of this calculation.

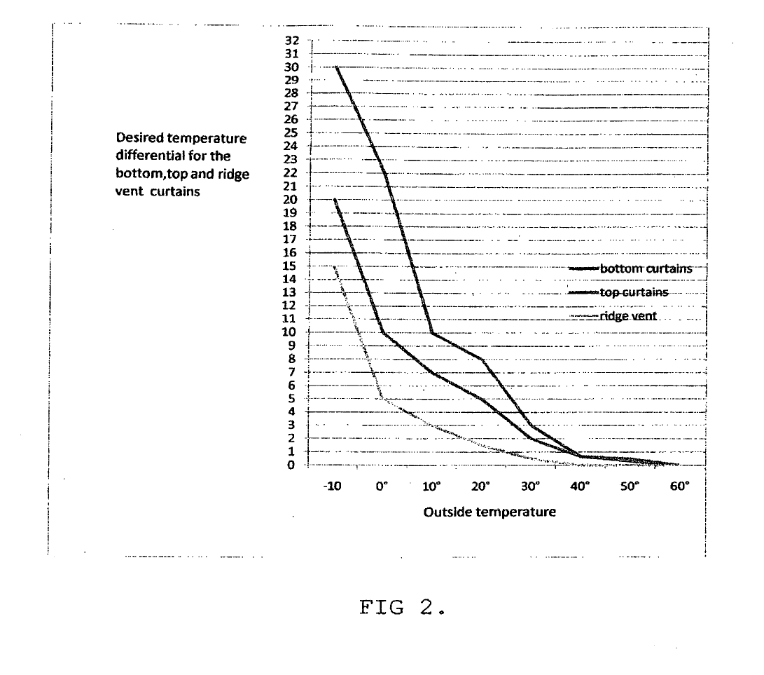

FIG. 2 is a graph showing how the temperature differential, a necessary step in the logic, is determined.

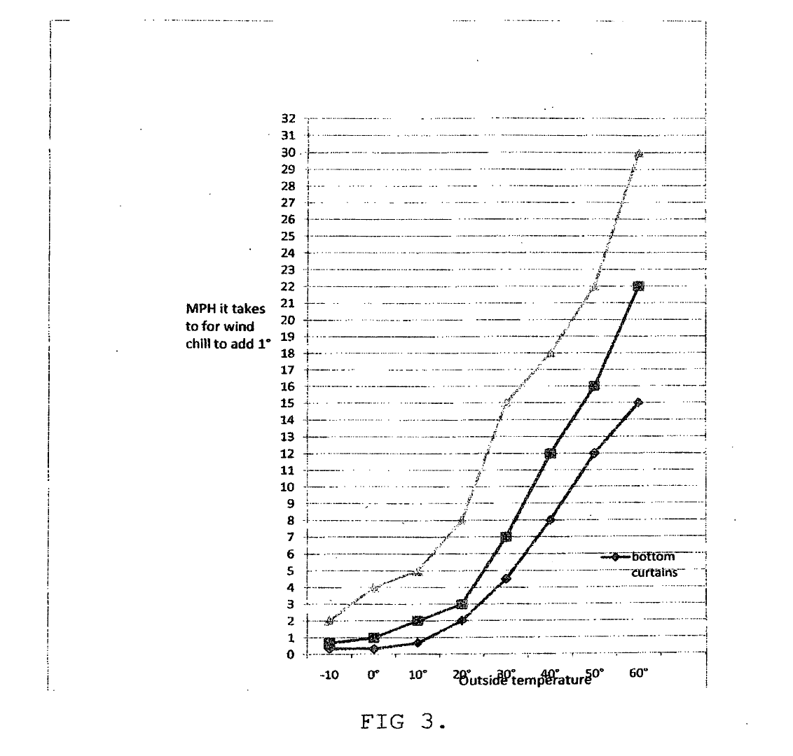

FIG. 3 is a graph showing how the wind chill, a necessary step in the logic, is determined.

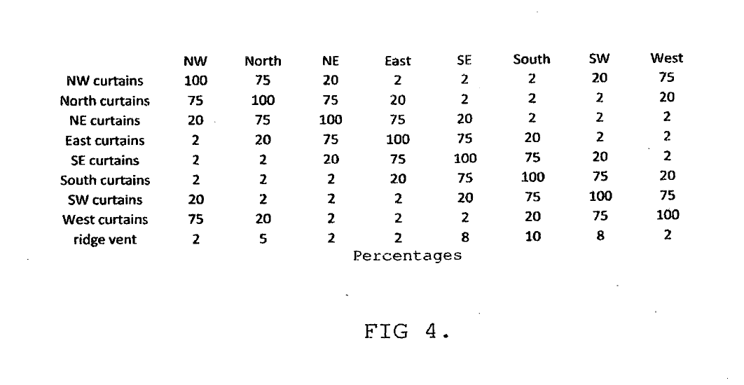

FIG. 4 is a table that lists the percentage of wind velocity (in MPH) used in the wind chill calculation.

### DETAILED DESCRIPTION OF THE PREFERRED EMBODIMENTS

Turning now to the detailed description of the invention, the method to dynamically open or close building/enclosure curtains in response to actual inside and outside temperatures, wind chill, and wind velocity in commercial animal enclosures.

The following detailed explanation is divided by the steps in the process to dynamically control the curtains in the building/enclosure.

Refer to FIG. 1, “Curtain Temperature Logic” flowchart. FIG. 1 is a flowchart that shows the steps in determining how much building/enclosure curtains will be dynamically opened or closed in response to changes in the internal and external environment. FIG. 1 will be used extensively in the following explanation.

### Step 1—Calculating the Temperature Differential

Refer again to FIG. 1. The first step (001) in curtain temperature logic is to calculate the “temperature differential.” A thermometer inside the building/enclosure registers the internal temperature and relays that datum to the controller. A thermometer outside the building/enclosure registers the actual outside temperature and also relays that to the controller. The controller determines the temperature differential using an algorithm that was formulated and based on observed experiential data. For our purposes and ease of understanding, that data has been transposed into a line graph, as shown in FIG. 2, “Temperature Differential.”

FIG. 2 shows three line graphs that represent the temperature differential for three curtains: ridge, top, and bottom. In the following explanation, the top curtain is used as an example; note that all other curtains follow similar logic as the top curtain. The graph in Figure B shows outside temperatures along the x axis. The inside temperature to which the controller will attempt to open or close (by raising or closing the curtains) is shown on the y axis. For example, if the outside temperature is 0° F., the controller will issue a command to close or open the curtain in an attempt to open and keep the inside temperature at 10° F. In this example, the temperature differential is calculated by adding the actual outside temperature (0°) to the desired inside temperature)(10°). Or, shown mathematically: 0°+10°=10°.

Once the temperature differential is calculated, the differential is temporarily stored in the controller's computer memory to be used in the following steps.

### Step 2—Calculating Wind Chill

Refer back to FIG. 1, the “Curtain Temperature Logic” flowchart. The next step in the process is to calculate the wind chill (002) and, based on that, to determine how many degrees to add to the temperature differential.

This begins by determining the speed (velocity) and direction of the wind that is striking the building/enclosure at the current time. This is accomplished using an anemometer. An anemometer, a device for measuring wind velocity, is mounted on the building and is physically connected to the controller. As the wind strikes the anemometer, the velocity (in MPH) and direction are relayed to the controller. Within the controller wind velocity and direction data are plugged into the following formula to determine the wind chill.
Wind Chill Wind Velocity in MPH divided by the MPH it takes for the wind chill to add 1° multiplied by the percentage of MPH for a specific curtain and wind direction

In the following discussion, example data will be used to explain how the wind chill is calculated and then used to continue the curtain temperature logic discussion. However, before beginning, it should be again noted that each curtain is individually controlled and that the following example calculation is for just one single curtain—similar calculations are occurring for all of the other curtains covering the building. It is critically important to understand that each curtain operates individually, closing or rising in response to changes in outside and inside temperatures, wind velocity, and wind chill. The following example will be explained using only one curtain; however, the same process is used for all curtains.

For the following wind chill calculation example, assume that the:
Wind chill will be calculated for the north-facing top curtain
Wind is blowing from the southeast
Wind velocity is 20 MPH
Actual outside temperature is 0°

Based on the data above, the wind chill calculation begins by dividing the wind velocity in MPH by the MPH it takes for the wind chill to add 1°. In this example we know that the wind velocity is 20 MPH. The MPH it takes for the wind chill to add 1° is determined by referring to FIG. 3 “Wind Chill Curves.” FIG. 3 is a line graph that shows outside temperature along the x axis and MPH it takes for the wind chill to add 1° along the y axis. Note that this graph has been developed for this patent to show the data that the controller has within its memory to use when calculating wind chill.

To determine the wind speed in MPH that it takes for the wind chill to add 1°, we locate the outside temperature on the x axis, which as we stated above for this example is 0° ′ and trace vertically to the line that represents the top curtain. The MPH it takes for the wind chill to add 1% at 0° for the top curtain is 1. Stated another way, every 1 MPH of wind will add 1° to the wind chill when the curtain is using 100% of the wind.

Referring back to the formula above we calculate the wind velocity in MPH (20 MPH) divided by the MPH it takes for the wind chill to add 1° (1) for a sub-total of 20.

Refer to FIG. 4, “Percentage of MPH used for Wind Chill.” FIG. 4 is a table that identifies how much of the wind is used in the wind chill calculation for each of the curtains. In this example, as noted above, the wind is coming from the southeast and we are calculating the wind chill for the north-facing top curtain. To determine the percentage to use for the north curtains, locate the “North Curtains” row in the left-most column of curtains. Next locate the “SE” (southeast) column along the top (direction wind is coming from). Then look where the “North curtain” row and the “SE” column intersect. The percentage of MPH to use in this example is “2%.”

To finish the wind chill calculation, the sub-total of the first part of the calculation (20) is then multiplied by the 2% that was determined in the last paragraph. The result of this is 0.4 degrees, or a wind chill of 0.4 degrees.

### Step 3—Calculating the Dynamic Set Point.

Refer back to FIG. 1, the “Curtain Temperature Logic” flowchart. In the next step (003), the dynamic set point is calculated using the results of Steps 1 and 2 above. The dynamic set point is the temperature differential (determined in Step 1 above) added to the wind chill (determined in Step 2.) In our example, the result is 10.4 (10+0.4).

Therefore, 10.4 is stored as the dynamic set point for the north-facing curtain when the outside temperature is 0° and the wind is blowing from the SE at 20 MPH.

Step 4—Determining the Difference between the Actual Inside and Outside Temperatures

Refer back to FIG. 1, the “Curtain Temperature Logic” flowchart. In the next step (004) the difference between the inside and outside temperatures is determined. Assume in this example that the inside temperature is 15° F. The resulting temperature difference (in this example) is 15° (15° inside temperature minus 0° outside temperature.)

Step 5—Comparing the Actual Temperature Difference with the Dynamic Set Point

Refer back to FIG. 1, the “Curtain Temperature Logic” flowchart. In the next step (005) the difference between the outside and inside temperature (actual temperature difference) is compared to the difference between the dynamic set point that was determined in Step 3 above. Using the previous example, the comparison is between 10.4 (the dynamic set point) and 15 (the difference between outside and inside temperatures).

Refer again to FIG. 1, the “Curtain Temperature Logic” flowchart, (006). If the difference between the inside and outside temperatures (actual temperature difference) is greater than the dynamic set point, the controller will energize the curtain to open for a specific number of seconds (007). However, if the difference between inside and outside temperatures is less than the dynamic set point, the controller will energize the curtain to close for a specific number of seconds (008).

Use the example data calculated so far, since the difference between inside and outside temperature (actual temperature difference), which is 15 is greater than the dynamic set point, which is 10.4, the controller would send a message to energize the curtain to open for a specific number of seconds—thus opening the north-facing curtain.

Note that because this logic runs on all of the curtains simultaneously, that curtains may be dynamically raising on one side while closing on another—all in an attempt to adjust the internal temperature of the building/enclosure.

What is claimed is:

1. A method for automatically opening or closing curtains comprising: a dynamic control that uses a measurement of the external temperature to determine how much the curtains open or close based on the difference between the outside temperature and the inside temperature.

2. A method for determining the set point at which claim 1 is activated, wherein a wind chill calculation is used with the said difference in temperatures.

3. A method for calculating wind chill that consists of using wind velocity to determine how much wind it takes to add 1° to the inside temperature of an enclosure multiplied by a prevailing wind calculation.

4. A method for determining the prevailing wind of claim 3 from a table of wind direction and the percentage of wind that affects curtains on different sides of an enclosure.
